(19) United States
(12) Patent Application Publication
(10) Pub. No.: US 2025/0092988 A1
(43) Pub. Date: Mar. 20, 2025

(54) GRIP ASSEMBLY WITH REINFORCEMENT SKELETON STRUCTURE AND HANDHELD MONOPOD USING SAME

(71) Applicant: SHENZHEN YUANSU CHUANGDA TECHNOLOGY CO.,LTD, SHENZHEN (CN)

(72) Inventor: XIBIN XU, SHENZHEN (CN)

(21) Appl. No.: 18/671,003

(22) Filed: May 22, 2024

(30) Foreign Application Priority Data
Sep. 19, 2023 (CN) 202322546316.8

(51) Int. Cl. F16M 13/04; F16M 11/04; F16M 11/10; F16M 11/28; G03B 17/56

(52) U.S. Cl. CPC F16M 13/04; F16M 11/041; F16M 11/10; F16M 11/28; G03B 17/561

(57) ABSTRACT

Disclosed are a grip assembly with a reinforcement skeleton structure and a handheld monopod using the same. The grip assembly comprises an assembly stand, a telescopic rod and a grip portion, wherein a spindle groove is formed in one side of the assembly stand, a mounting column and a reinforcement skeleton are arranged on the other side of the assembly stand, and the reinforcement skeleton is coaxial with and inlaid in the mounting column. The reinforcement skeleton improves the connection rigidity of the assembly stand and the mounting column and also improves the support capacity of the assembly stand, thus effectively avoiding weight-induced deformation caused by upgrading of mobile phones.

### BACKGROUND OF THE INVENTION

### 1. Technical Field

The invention relates to the field of structures of handheld monopods, in particular to a grip assembly with a reinforcement skeleton structure and a handheld monopod using the same.

### 2. Description of Related Art

The increasingly powerful shooting performance of mobile terminals allows many self-media users to shoot video and photo materials by means of mobile phones, and in order to obtain better operating experience, more and more users use mobile phones together with handheld monopods to obtain materials.

In the prior art, existing handheld monopods typically comprise a handle, a rotating device and a clamping portion which are connected in sequence, a telescopic rod is received in the handle, and a telescopic tube with the minimum cross-section of the telescopic rod is disposed around and connected to a mounting column fixedly arranged on the rotating device. With the improvement of the shooting performance of mobile phones, the weight of the mobile phones also increases, posing a further challenge to the support capacity of the rotating device; and considering the portability of the handheld monopods, it is inadvisable to blindly expand the size of the rotating device. Therefore, a handheld monopod which is more reasonable in structure, small in size and good in support capacity is urgently needed to overcome the defects of existing handheld monopods.

### BRIEF SUMMARY OF THE INVENTION

The objective of the invention is to provide a solution to solve the technical problem of insufficient support capacity of handheld monopods in the prior art.

To fulfill the above objective, the invention provides a grip assembly with a reinforcement skeleton structure, comprising:
an assembly stand, a spindle groove being formed in one side of the assembly stand, a mounting column and a reinforcement skeleton being arranged on the other side of the assembly stand, and the reinforcement skeleton being coaxial with and inlaid in the mounting column;
a telescopic rod, a telescopic tube with a minimum cross-section of the telescopic rod being disposed around a columnar surface of the mounting column; and
a grip portion, the grip portion being provided with a cavity, and the telescopic rod being arranged in the cavity.

As an improvement of the application, corresponding to a contour structure formed by the assembly stand and the mounting column, the reinforcement skeleton is formed with a first skeleton and a second skeleton, the first skeleton is arranged in the assembly stand, and the second skeleton is arranged in the mounting column.

As an improvement of the application, an end, away from the mounting column, of the second skeleton extends out of the mounting column to be received in a tube cavity of the telescopic tube.

As an improvement of the application, at least one guide groove is formed in the columnar surface of the mounting column and arranged in an axial direction of the mounting column, and a guide protrusion matched with the guide groove is arranged on an inner wall of the telescopic tube with the minimum cross-section of the telescopic rod.

As an improvement of the application, the grip portion comprises a tube segment and a grip segment connected with the tube segment, and a receiving groove for receiving a remote control is formed in a cylindrical surface of the tube segment.

As an improvement of the application, the grip portion comprises a link and a plurality of support legs, one end of the link is connected with the tube segment, recesses matched with the support legs are formed in a side edge of the other end of the link, the number of the recesses is equal to the number of the support legs, and the plurality of support legs are pivotably connected into the corresponding recesses; and the plurality of support legs are allowed be unfolded or folded with one ends of the recesses as pivots to be in an erected state or a handheld state.

As an improvement of the application, in the handheld state, the plurality of support legs are folded to form a cylinder, and a cylindrical surface of the cylinder is flush with the cylindrical surface of the tube segment.

The application further provides a handheld monopod, comprising a clamping portion and the grip assembly, wherein one end of the clamping portion is used for clamping a mobile phone, and the other end of the clamping portion is rotatably connected to the spindle groove.

The invention has the following beneficial effects: compared with the prior art, the invention provides a grip assembly with a reinforcement skeleton structure and a handheld monopod using the same, and the grip assembly comprises an assembly stand, a telescopic rod and a grip portion; a spindle groove is formed in one side of the assembly stand, a mounting column and a reinforcement skeleton are arranged on the other side of the assembly stand, and the reinforcement skeleton is coaxial with and inlaid in the mounting column; a telescopic tube with a minimum cross-section of the telescopic rod is disposed around a columnar surface of the mounting column; the grip portion is provided with a cavity, and the telescopic rod is arranged in the cavity; the reinforcement skeleton improves the connection rigidity of the assembly stand and the mounting column and effectively improves the connection stability of the assembly stand and the mounting column, thus affectively improving the support capacity of the assembly stand to overcome the challenge in weight caused by upgrading of mobile phones.

### BRIEF DESCRIPTION OF THE SEVERAL VIEWS OF THE DRAWINGS

FIG. 1 is a perspective view of a grip assembly according to the invention;

FIG. 2 is an exploded view of the grip assembly according to the invention;

FIG. 3 is a schematic diagram of an assembly stand of the grip assembly according to the invention;

FIG. 4 is an exploded view of the assembly stand of the grip assembly according to the invention;

FIG. 5 is a partial view of area A in FIG. 2 according to the invention.

### REFERENCE SIGNS OF MAIN ELEMENTS

1, assembly stand; 11, spindle groove; 12, mounting column; 121, guide groove; 13, reinforcement skeleton;
131, first skeleton; 132, second skeleton;
2, telescopic rod; 21, telescopic tube;
3, grip portion; 31, tube segment; 311, receiving groove; 312, remote control; 32, grip segment;
321, support leg; 33, link; 331, recess.

### DETAILED DESCRIPTION OF THE INVENTION

To better clarify the invention, the invention is further described below in conjunction with accompanying drawings.

In the following description, details of generally selected embodiments are provided below to gain a deeper understanding of the invention. Obviously, the embodiments in the following description are merely illustrative ones, and are not all possible ones of the invention. It should be understood that the following specific embodiments are used for explaining the invention rather than limiting the invention.

It should be understood that terms “include” and/or “comprise” used in the description indicates the presence of features, entities, steps, operations, elements or assemblies indicated, not excluding the presence or addition of one or more other features, entities, steps, operations, elements, assemblies or combinations thereof.

In the prior art, existing handheld monopods typically comprise a handle, a rotating device and a clamping portion which are connected in sequence, a telescopic rod is received in the handle, and a telescopic tube with the minimum cross-section of the telescopic rod is disposed around and connected to a mounting column fixedly arranged on the rotating device. With the improvement of the shooting performance of mobile phones, the weight of the mobile phones also increases, posing a further challenge to the support capacity of the rotating device; and considering the portability of the handheld monopods, it is inadvisable to blindly expand the size of the rotating device. Therefore, a handheld monopod which is more reasonable in structure, small in size and good in support capacity is urgently needed to overcome the defects of existing handheld monopods.

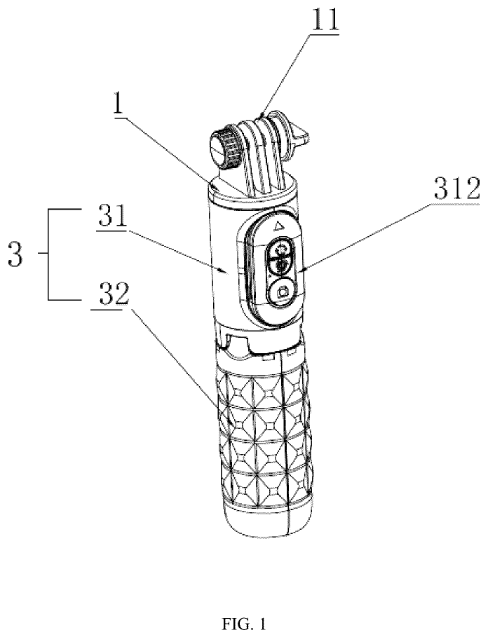

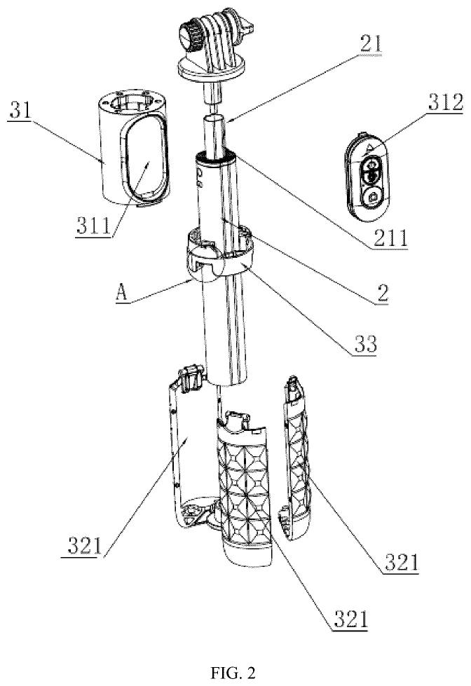

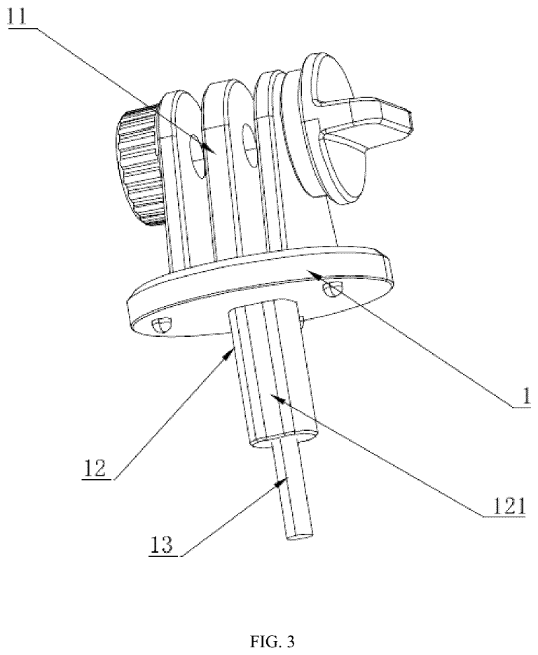

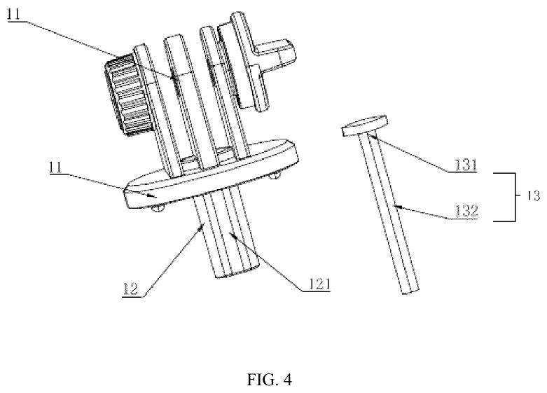

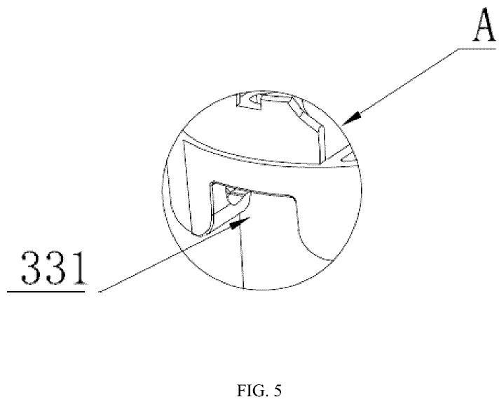

To solve the abovementioned technical problems, the application provides a grip assembly with a reinforcement skeleton structure. Referring to FIG. 1 to FIG. 5, the grip assembly with a reinforcement skeleton structure comprises an assembly stand 1, a telescopic rod 2 and a grip portion 3; a spindle groove 11 is formed in one side of the assembly stand 1, a mounting column 12 and a reinforcing skeleton 13 are arranged on the other side of the assembly stand 1, and the reinforcing skeleton 13 is coaxial with the mounting column 12 and inlaid in the mounting column 12; the grip portion 3 is provided with a cavity, and the telescopic rod 2 is arranged in the cavity; and the reinforcing skeleton 13 is made from a high-rigidity material such as metal, a composite polymer material PPS, or the like.

Generally, the mounting column 12 and the assembly stand 1 are formed integrally to form an important joint, which is mainly used for connecting the grip portion to a clamping portion. Because the weight of existing mobile phones is over 250 g, the mounting column 12 and the assembly stand 1 will break and be separated from each other if the support capacity of the mounting column 12 and the assembly stand 1 is insufficient. As a product to be held with hands, it is inadvisable to improve the overall strength by increasing the size of the mounting column or the assembly stand, so as to improve the support capacity. A telescopic tube 21 with a minimum cross-section of the telescopic rod 2 is disposed around a columnar surface of the mounting column 12. The reinforcing skeleton 13 improves the connection rigidity of the assembly stand 1 and the mounting column 12 and effectively improves the connection stability of the assembly stand 1 and the mounting column 12, thus improving the support capacity of the assembly stand 1 to effectively overcome the challenge in weight caused by upgrading of mobile phones without changing the original sizes of the assembly stand 1 and the mounting column 12.

In this embodiment, corresponding to a contour structure formed by the assembly stand 1 and the mounting column 12, the reinforcing skeleton 13 is formed with a first skeleton 131 and a second skeleton 132, the first skeleton 131 is arranged in the assembly stand 1, and the second skeleton 132 is arranged in the mounting column 12. It can be easily understood that if the assembly stand 1 is shaped like a truncated cone, the mounting column 12 will be shaped like a cylinder; and correspondingly, the first skeleton 131 is shaped like a scaled-down truncated cone and arranged in the assembly stand 1, and the second skeleton 132 is shaped like a scaled-down cylinder and arranged in the mounting column 12. The first skeleton 131 and the second skeleton 132 effectively improve the connection stability and overall strength of the assembly stand 1 and the mounting column 12, thus effectively improving the overall support capacity of the assembly stand.

Further, the second skeleton 132 extends out of the mounting column 12 to be received in a tube cavity of the telescopic tube 21. It can be easily understood that the tube cavity of the telescopic tube is further used without increasing the overall size, and the extended second skeleton 132 effectively improves the overall strength of the mounting column 12 and the assembly stand 1.

In this embodiment, at least one guide groove 121 is formed in the columnar surface of the mounting column 12 and arranged in an axial direction of the mounting column 12, and a guide protrusion matched with the guide groove 121 is arranged on an inner wall of the telescopic tube 21 with the minimum cross-section of the telescopic rod 2. It can be easily understood that the telescopic tube can be quickly assembled on the mounting column 12 by means of the guide protrusion and the guide groove 121 matched with the guide protrusion. It should be noted, by way of example, that the telescopic rod 2 is formed a plurality of telescopic tubes 21, which are sleeved with each other and the cross-sections of which become smaller gradually, guide slots are formed between every two adjacent telescopic tubes 21, and protrusions are correspondingly formed in inner walls of the telescopic tubes and matched with the guide slots, such that the telescopic tubes can stably slide with respect to each other. In the application, the guide protrusion is the protrusion corresponding to the guide groove in the telescopic tube with the minimum cross-section and is matched with the guide groove 121 to quickly assemble the telescopic tube on the mounting column.

In this embodiment, the grip portion 3 comprises a tube segment 31 and a grip segment 32 connected with the tube segment 31, and a receiving groove 311 for receiving a remote control 312 is formed in a cylindrical surface of the tube segment 31. It can be easily understood that to allow users to control a mobile phone more flexibly, the remote control 312 may be connected with the mobile phone by Bluetooth, and quick photographing, starting or stopping of video shooting and other functions can be realized by pressing keys on the remote control 312.

In this embodiment, the grip segment 32 comprises a link 33 and a plurality of support legs 321, one end of the link 33 is connected with the tube segment 31, and recesses 331 matched with the support legs 321 are formed in a side edge of the other end of the link 33, the number of the recesses 331 is equal to the number of the support legs 321, and the plurality of support legs 321 are pivotably connected into the corresponding recesses 33; and the plurality of support legs 321 are allowed to be unfolded or folded with one ends of the recesses 33 as pivots to be in an erected state or a handheld state. It can be easily understood that when the plurality of support legs 321 are unfolded to be in the erected state, materials on a plane can be shot. Anti-slip protrusions may be arranged in arrays n outer surfaces of the support legs 321 to improve grip stability.

In this embodiment, in the handheld state, the plurality of support legs 321 are folded to form a cylinder, and a cylindrical surface of the cylinder is flush with the cylindrical surface of the tube segment 31. In this way, the appearance impression and smoothness of the grip assembly are effectively improved.

The application further provides a handheld monopod, comprising a clamping portion and the grip assembly, wherein one end of the clamping portion is used for clamping a mobile phone, and the other end of the clamping portion is rotatably connected to the spindle groove. The handheld monopod may be specifically implemented as, for example, a selfie stick or a camera stabilizer.

The invention has the following advantages:

The reinforcing skeleton improves the connection rigidity of the assembly stand and the mounting column and effectively improves the connection stability of the assembly stand and the mounting column, thus effectively improving the support capacity of the assembly stand to effectively overcome the challenge in weight caused by upgrading of mobile phones without changing the original sizes of the assembly stand and the mounting column.

Several specific embodiments of the invention are disclosed above, and the invention is not limited to the above embodiments. Any variations that can be obtained by those skilled in the art should fall within the protection scope of the invention.

What is claimed is:

1. A grip assembly with a reinforcement skeleton structure, comprising:
an assembly stand, a spindle groove being formed in one side of the assembly stand, a mounting column and a reinforcement skeleton being arranged on the other side of the assembly stand, and the reinforcement skeleton being coaxial with and inlaid in the mounting column;
a telescopic rod, a telescopic tube with a minimum cross-section of the telescopic rod being disposed around a columnar surface of the mounting column; and
a grip portion, the grip portion being provided with a cavity, and the telescopic rod being arranged in the cavity.

2. The grip assembly with a reinforcement skeleton structure according to claim 1, wherein corresponding to a contour structure formed by the assembly stand and the mounting column, the reinforcement skeleton is formed with a first skeleton and a second skeleton, the first skeleton is arranged in the assembly stand, and the second skeleton is arranged in the mounting column.

3. The grip assembly with a reinforcement skeleton structure according to claim 2, wherein an end, away from the mounting column, of the second skeleton extends out of the mounting column to be received in a tube cavity of the telescopic tube.

4. The grip assembly with a reinforcement skeleton structure according to claim 2, wherein at least one guide groove is formed in the columnar surface of the mounting column and arranged in an axial direction of the mounting column, and a guide protrusion matched with the guide groove is arranged on an inner wall of the telescopic tube with the minimum cross-section of the telescopic rod.

5. The grip assembly with a reinforcement skeleton structure according to claim 1, wherein the grip portion comprises a tube segment and a grip segment connected with the tube segment, and a receiving groove for receiving a remote control is formed in a cylindrical surface of the tube segment.

6. The grip assembly with a reinforcement skeleton structure according to claim 5, wherein the grip portion comprises a link and a plurality of support legs, one end of the link is connected with the tube segment, recesses matched with the support legs are formed in a side edge of the other end of the link, the number of the recesses is equal to the number of the support legs, and the plurality of support legs are pivotably connected into the corresponding recesses; and the plurality of support legs are allowed be unfolded or folded with one ends of the recesses as pivots to be in an erected state or a handheld state.

7. The grip assembly with a reinforcement skeleton structure according to claim 6, wherein in the handheld state, the plurality of support legs are folded to form a cylinder, and a cylindrical surface of the cylinder is flush with the cylindrical surface of the tube segment.

8. A handheld monopod, comprising a clamping portion and the grip assembly according to claim 1, wherein one end of the clamping portion is used for clamping a mobile phone, and the other end of the clamping portion is rotatably connected to the spindle groove.
